(19) United States
(12) Patent Application Publication
(10) Pub. No.: US 2008/0100394 A1
(43) Pub. Date: May 1, 2008

(54) Microstrip to Coplanar Waveguide Transition

(75) Inventors: Alexandros Margomenos, Ann Arbor, MI (US); Linda P.B Katehi, Zionsville, IN (US)

Correspondence Address: MILLER IP GROUP, PLC;EMAG TECHNOLOGIES, INC., 42690 WOODWARD AVE., SUITE 200, BLOOMFIELD HILLS, MI, 48304, US

(73) Assignee: EMAG TECHNOLOGIES, INC., Ann Arbor, MI (US)

(21) Appl. No.: 11/940,843

(22) Filed: Nov. 15, 2007

Related U.S. Application Data
(63) Continuation-in-part of application No. 11/171,628, filed on Jun. 30, 2005, now Pat. No. 7,315,223.
(60) Provisional application No. 60/584,328, filed on Jun. 30, 2004.

(51) Int. Cl. H01P 5/08

(52) U.S. Cl. 333/32

(57) ABSTRACT

Micro-machined microstrip-to-coplanar waveguide transitions for vertically integrated RF systems on chip. In one embodiment, a microstrip line is formed on one surface of a semiconductor wafer and a coplanar waveguide is formed on an opposite surface of the wafer, where the microstrip line and the coplanar waveguide are electrically coupled by vias extending through the wafer. In another embodiment, a semiconductor device is provided that includes a first wafer and a second wafer. The first wafer includes a microstrip line formed on one side that is electrically coupled to a coplanar waveguide formed on an opposite side of the first wafer. The second wafer includes a coplanar waveguide that is electrically coupled to the coplanar waveguide on the first wafer by electrical bumps.

### CROSS REFERENCE TO RELATED APPLICATIONS

This application is a Continuation-in-Part application of U.S. patent application Ser. No. 11/171,628, titled Microstrip-to-Microstrip RF Transition Including Co-Planar Waveguide, filed Jun. 30, 2005, which claims priority to U.S. Provisional Patent Application No. 60/584,328, titled Microstrip-to-Microstrip RF Transition Including Co-Planar Waveguide, filed Jun. 30, 2004.

### BACKGROUND OF THE INVENTION

1. Field of the Invention

This invention relates generally to micro-machined transitions for vertically integrated RF systems on chip and, more particularly, to micro-machined microstrip-to-coplanar waveguide transitions for vertically integrated RF systems on chip.

2. Discussion of the Related Art

Micro-electromechanical switches (MEMS) used for RF applications is a technology area that has potential for providing a major impact on existing RF architectures in sensors and communications devices by reducing the weight, cost, size and power dissipation in these devices, possibly by a few orders of magnitude. Key devices for existing RF architectures include switches in radar systems and filters in communications systems. However, while MEMS technology has demonstrated the potential to revolutionize such devices, MEMS devices have not been specifically designed for performance in harsh environments, typically required for military applications, such as unmanned aerial vehicles (UAV) and national missile defense (NMD) systems. Particularly, MEMS technology requires further development in order to be able to provide effective performance under large temperature variations, strong vibrations and other extreme environmental conditions.

An appropriate packaging scheme that combines the properties of traditional high-speed packages and compatibility with planar technology offers a solution to this issue. Packaging is one of the most critical parts of the RF and MEMS fabrication process. Packaging is the most expensive step in the production line and will ultimately determine the performance and longevity of the device.

A large number of publications exist relating to RF MEMS based circuits, including phase shifters, single-pole multiple-through circuits, tunable filters, matching networks, etc. Many of these circuits have been designed based on a microstrip line configuration. Therefore, in order to develop a compatible on-wafer packaging scheme, a microstrip-to-microstrip transition needs to be provided. Such a transition for a MEMS is disclosed in U.S. Pat. No. 6,696,645 describing a coplanar waveguide (CPW)-to-CPW transition. The transition needs to be as broadband as possible, with minimum insertion losses and no parasitic resonance up to 50 GHz.

It is an important design consideration for a broadband microstrip-to-microstrip transition to maintain a characteristic impedance of the transition at 50Ω, especially at high frequency (>5 GHz). The 50Ω characteristic impedance through the transition is necessary to minimize signal reflections that would otherwise provide signal loss and degrade device performance. The design problem occurs because of the need for a wider microstrip line, which provides a lower impedance, in order to accommodate for the anisotropic etching of the vias through a semiconductor silicon wafer. When silicon is etched in potassium hydroxide or tetramethyl ammonia hydroxide, the etch rate of the <100> crystal plane is much higher than the etch rate of the <111> plane. This means that the final etched structure has a pyramidal shape found in the <111> planes of the silicon crystal. The angle between the <111> and the <100> planes is 54.74°. Other semiconductor wafer materials, such as GaAs, InP, GaN, etc., have similar anisotropic etching profiles. Therefore, in order to get a 20×20 μm square at the bottom of the via, a 160×160 μm square at the top of the via is required. This means that the width of the microstrip line needs to be at least 200 μm at the top of the via to accommodate for the size of the top of the vias. The wider microstrip line has a decreased characteristic impedance (approximately 25-30Ω). This mismatch increases the return loss of a back-to-back transition, thus reducing the overall bandwidth of the structure.

FIG. 1 is a perspective view of a microstrip transition circuit 10 that illustrates this problem. The transition circuit 10 includes an upper microstrip line 12, a lower microstrip line 14, an upper ground plane 16 and a lower ground plane 18. A top semiconductor wafer (not shown), such as a silicon wafer, would be provided between the microstrip line 12 and the ground plane 16 and a bottom semiconductor wafer (not shown), such as a silicon wafer, would be provided between the microstrip line 14 and the ground plane 18, both of which have been removed for clarity purposes. The microstrip line 12 is patterned on a top surface of the top semiconductor wafer, the upper ground plane 16 is patterned on the bottom surface of the top semiconductor wafer, the microstrip line 14 is patterned on the top surface of the bottom semiconductor wafer, and the lower ground plane 18 is patterned on the bottom surface of the bottom semiconductor wafer.

A signal via 20 is formed through the top semiconductor wafer and is in electrical contact with the microstrip lines 12 and 14. Two ground vias 22 and 24 are formed through the bottom semiconductor wafer and provide an electrical contact between the upper ground plane 16 and the lower ground plane 18. The vias 20, 22 and 24 have a “pyrmidical shape” from top to bottom because of the anisotropic etch rates through the crystal planes of silicon when the opening for the vias 20, 22 and 24 are formed, as discussed above. The microstrip lines 12 and 14 and the vias 20, 22 and 24 would be made of a suitable metal, as would be well understood to those skilled in the art.

Typically, the thickness of the semiconductor wafers is about 100 μm because this is the minimum wafer thickness for current wafer fabrication processes. It is desirable that the semiconductor wafers be as thin as possible so that the parasitic inductances generated by the vias 20, 22 and 24 is as minimal as possible. When the openings for the vias 20, 22 and 24 are etched for a wafer of this thickness, the timing of the etch produces about a 160×160 μm metallized square at the top end of the vias 20, 22 and 24 so that the etch produces about a 20×20 μm square at the bottom end of the vias 20, 22 and 24. The size of the top end of the vias 20, 22 and 24 ensures that the openings for the vias 20, 22 and 24 will be formed all the way through the thickness of the wafer.

The width of the microstrip line 12 is about 80 μm to provide the desired 50Ω. However, a widened portion 26 of the microstrip line 20 that makes electrical contact with the top end of the via 20 is wider than the metallized square at the top of the via 20 to provide a suitable electrical contact and the proper orientation and alignment. For the dimensions being discussed herein, the width of the widened portion 26 would be between 200 and 220 μm. Because the wider portion 26 is wider than the rest of the microstrip line 12, it has a different characteristic impedance, typically 25-30Ω. A tapered transition 28 between the widened portion 26 and the rest of the microstrip line 12 minimizes reflections provided by the change in the characteristic impedance, but does not eliminate them. Thus, significant signal loss occurs at the transition between the microstrip line 12 and the via 20, especially at high frequencies. The microstrip line 14 includes the same size transition to a widened portion 46 at the bottom end of the via 20 so as to maintain the 25-30Ω characteristic impedance.

### SUMMARY OF THE INVENTION

In accordance with the teachings of the present invention, micro-machined microstrip-to-CPW transitions for vertically integrated RF systems on chip are disclosed. In one embodiment, a microstrip line is formed on one surface of a semiconductor wafer and a coplanar waveguide is formed on an opposite surface of the wafer, where the microstrip line and the coplanar waveguide are electrically coupled by vias extending through the wafer. In another embodiment, a semiconductor device is provided that includes a first wafer and a second wafer. The first wafer includes a microstrip line formed on one side that is electrically coupled to a coplanar waveguide formed on an opposite side of the first wafer. The second wafer includes a coplanar waveguide that is electrically coupled to the coplanar waveguide on the first wafer by electrical bumps.

Additional features of the present invention will become apparent from the following description and appended claims, taken in conjunction with the accompanying drawings.

### BRIEF DESCRIPTION OF THE DRAWINGS

FIG. 1 is a perspective view of a microstrip-to-microstrip transition circuit for an RF circuit of the type known in the prior art;

FIG. 2 is a top view of a microstrip transition circuit including a short CPW section, according to an embodiment of the present invention;

FIG. 3 is a perspective view of a microstrip-to-microstrip transition circuit for an RF circuit including CPW sections, according to another embodiment of the present invention;

FIG. 4 is a perspective view of a microstrip-to-microstrip transition circuit, according to another embodiment of the present invention;

FIG. 5 is a graph with frequency on the horizontal axis and S-parameters on the vertical axis showing transition and reflection losses for the microstrip-to-microstrip transition circuit shown in FIG. 4;

FIGS. 6(a) and 6(b) are a top view and bottom view, respectively, of a wafer showing a microstrip-to-CPW transition, according to another embodiment of the present invention; and

FIG. 7 is a perspective view of a wafer-to-wafer transition employing connector bumps, according to another embodiment of the present invention.

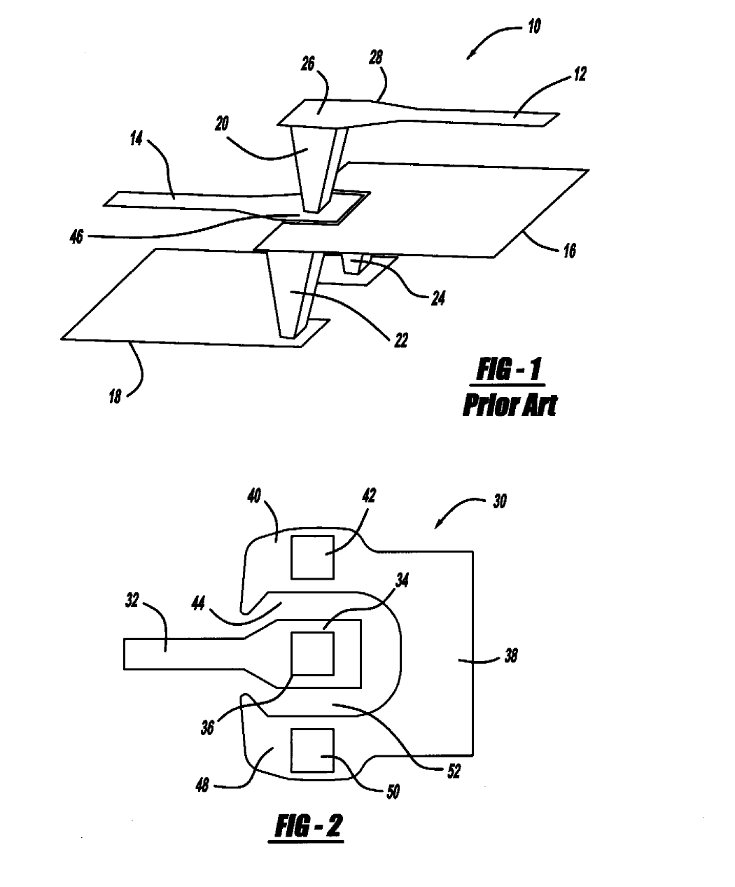

### DETAILED DESCRIPTION OF THE EMBODIMENTS

The following discussion of the embodiments of the invention directed to micromachined microstrip-to-CPW transitions for vertically integrated RF systems on chip is merely exemplary in nature and is in no way intended to limit the invention or its applications or uses.

The following discussion of the embodiments of the invention includes various signal lines, ground planes and semiconductor wafers. The various signal lines and ground planes are metallized layers formed on the substrate, and can be deposited and patterned by any suitable process known to those skilled in the art. Further, the various signal lines and ground planes can have any suitable thickness and be made of any suitable electrical material, such as copper and gold. Further, the various substrates and wafers can be any suitable substrate or wafer for the purposes described herein, including silicon and group III-V semiconductor materials.

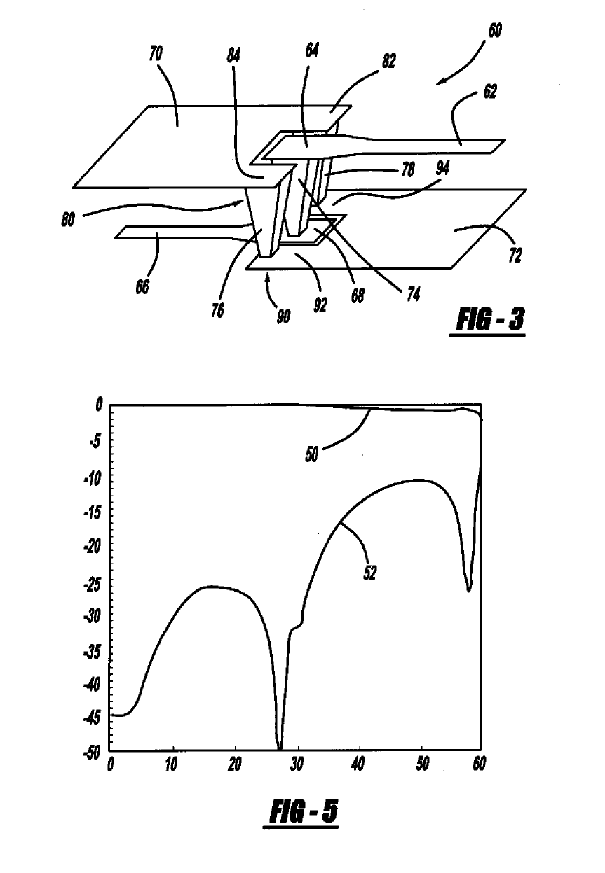

FIG. 2 is a top view of a microstrip transition circuit 30, according to one embodiment of the present invention. The transition circuit 30 includes a microstrip line 32 having a widened portion 34 electrically coupled to a signal via 36. The transition circuit 30 also includes a ground plane 38 having a first waveguide portion 40 electrically coupled to a first ground via 42, and defining a slot 44 between the portion 40 and the widened portion 34. The ground plane 38 also includes a second waveguide portion 48 electrically coupled to a second ground via 50, and defining a slot 52 between the waveguide portion 48 and the widened portion 34 of the microstrip line 32.

The combination of the waveguide portions 40 and 48 of the ground plane 38, the widened portion 34 of the microstrip line 32 and the slots 44 and 52 define a short CPW that has a certain characteristic impedance. The narrow portion of the microstrip line 32 has a characteristic impedance defined by the width of the microstrip line 32. The characteristic impedance of the CPW is defined by the width of the widened portion 34 and the width of the slots 44 and 52. The width of the widened portion 34 is defined by the diameter of the top end of the signal via 36, and the width of the slots 44 and 52 are selected so that the CPW has a characteristic impedance that matches the characteristic impedance of the narrow part of the microstrip line 32 for the width of the widened portion 34.

The CPW is wide enough to accommodate the anisotropic etching of the vias 36, 42 and 50. By utilizing this approach, the RF signal sees the minimum mismatch, and therefore the return loss can be kept below −10 dB for a wider bandwidth of operation.

After the via holes are etched, the coplanar waveguide ground planes are connected forming the microstrip ground plane, while the signal line transitions at the backside of the semiconductor wafer. This design can also be used for a microstrip line-to-coplanar waveguide transition because for some integrated RF circuits it is preferable to use a different type of interconnect on the inside and outside of the package.

FIG. 3 is a perspective view of a microstrip-to-microstrip transition circuit 60 employing CPWs of the type shown in FIG. 2, where the circuit 60 is comparable to the circuit 10. In this embodiment, only a single semiconductor wafer (not shown) is necessary. The semiconductor wafer can be silicon, GaAs, InP, silicon-germanium, etc. The circuit 60 includes an upper microstrip line 62 including a widened portion 64 patterned on the top surface of the semiconductor wafer, and a lower microstrip transition line 66 including a widened portion 68 patterned on the bottom surface of the semiconductor wafer. A top ground plane 70 is deposited on the top surface of the semiconductor wafer and a bottom ground plane 72 is deposited on the bottom surface of the semiconductor wafer. A signal via 74 is provided through the semicondcutor wafer and is in electrical contact with the widened portions 64 and 68 of the microstrip lines 62 and 66, respectively. Likewise, two ground vias 76 and 78 are provided through the semiconductor wafer and are in electrical contact with the top ground plane 70 and the bottom ground plane 72.

The circuit 60 further includes a first CPW 80 defined by the widened portion 64 of the microstrip transition line 62 and two extended portions 82 and 84 of the ground plane 70, and the slots therebetween. Likewise, the transition circuit 60 includes a second CPW 90 defined by the widened portion 68, two extended portions 92 and 94 of the ground plane 72, and the slots therebetween. The CPW 80 and the CPW 90 have an effective characteristic impedance that matches the characteristic impedance of the narrow portion of the microstrip lines 62 and 66. Therefore, signals propagating on the microstrip lines 62 and 66 and through the wafer have a minimal return loss. In one embodiment, the characteristic impedance is 50Ω.

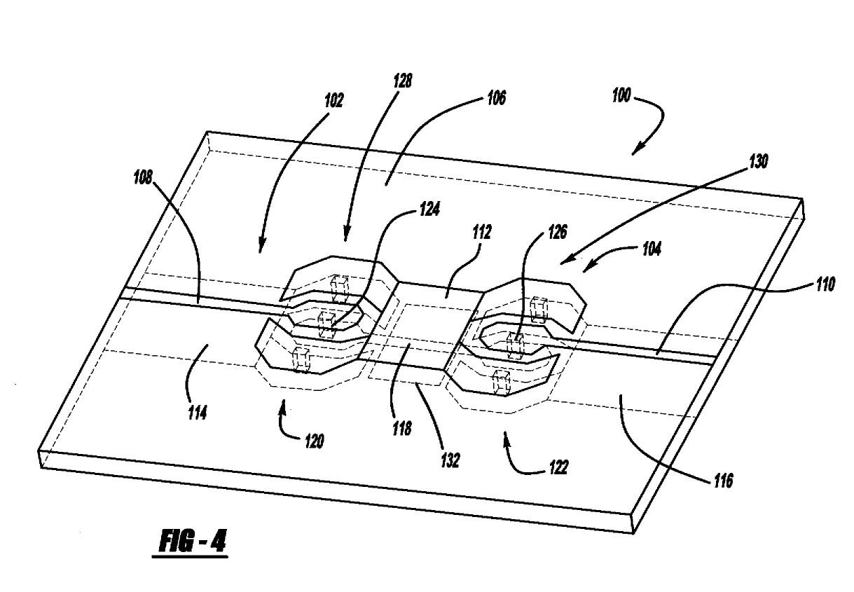

FIG. 4 is a perspective view of an RF circuit 100 employing two back-to-back microstrip transition circuits 102 and 104 of the type shown in FIG. 3. In this embodiment, a silicon wafer 106 is shown as part of the circuit 100. A first microstrip transition line 108, a second microstrip transition line 110 and a first ground plane 112 are patterned on a top surface of the wafer 106. A second ground plane 114, a third ground plane 116 and a third microstrip line 118 are patterned on a bottom surface of the wafer 106. Four CPWs 120, 122, 128 and 130 transfer the signal from the microstrip line 108 to the microstrip line 118 and then to the microstrip line 110 in the manner as discussed above through signal vias 124 and 126.

One advantage of the design of the present invention is that in the case of an on-wafer packaging architecture, the ground plane of the microstrip can be used for forming a sealing ring. This means that the ring will always be connected to the RF line, and therefore the parasitic resonance due to its length will be reduced or even eliminated. Moreover, because most of the developed RF MEMS are suspended over microstrip lines, this proposed packaging architecture can be of great interest in the industry. In order to illustrate such a configuration, a MEMS 132 is shown formed to the bottom surface of the wafer 106 and electrically coupled to the microstrip line 118.

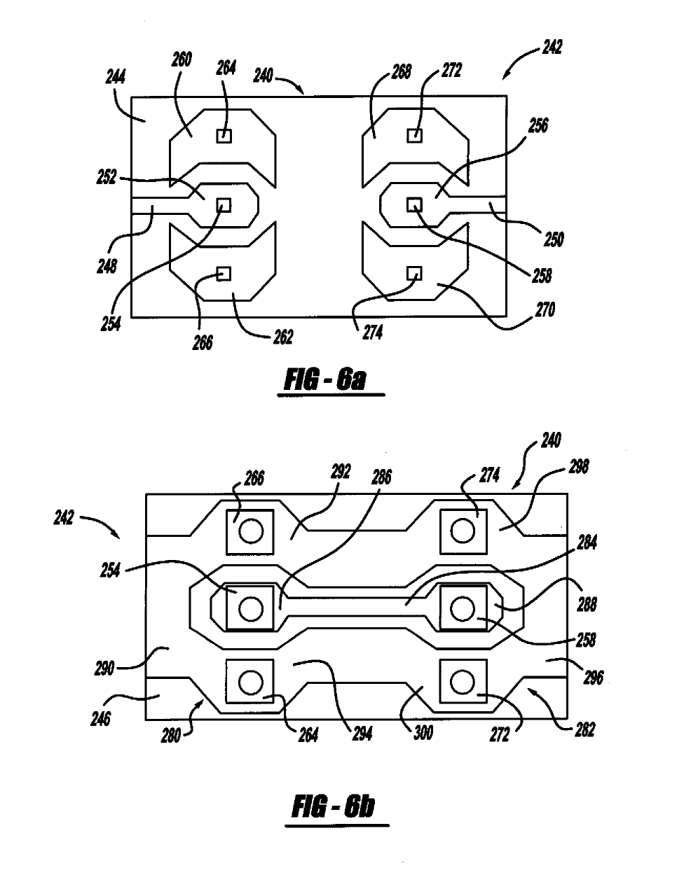

FIG. 5 is a graph with frequency on the horizontal axis and S-parameters on the vertical axis showing the insertion and return loss for the circuit 10 at line 50 and the return loss at line 52.

Silicon micro-machining is being developed in the art for creating miniaturized multi-chip packaged modules. Mature bulk and surface micro-machining processes allow the fabrication of complex three-dimensional structures, which can replace traditional RF transceiver front-end components. Miniaturized cavity filters, including both resonant and evanescent mode filters, three-dimensional interconnects, RF MEMS and wafer-scale packaging architectures can be monolithically integrated on a single chip creating a multi-functional, tunable system. However, low-loss, manufacturable RF vertical transitions are critical components for a successful three-dimensional circuit integration. While most RF transitions reported in the literature are planar, a small number of architectures have been demonstrated that have the potential to allow successful three-dimensional integration. Integration of three-dimensional RF transitions onto a group III-V semiconductor or silicon substrate using an industry-manufacturable process is one step toward manufacturable, multi-layer integration of packaged active and passive components including FETs and RF MEMS.

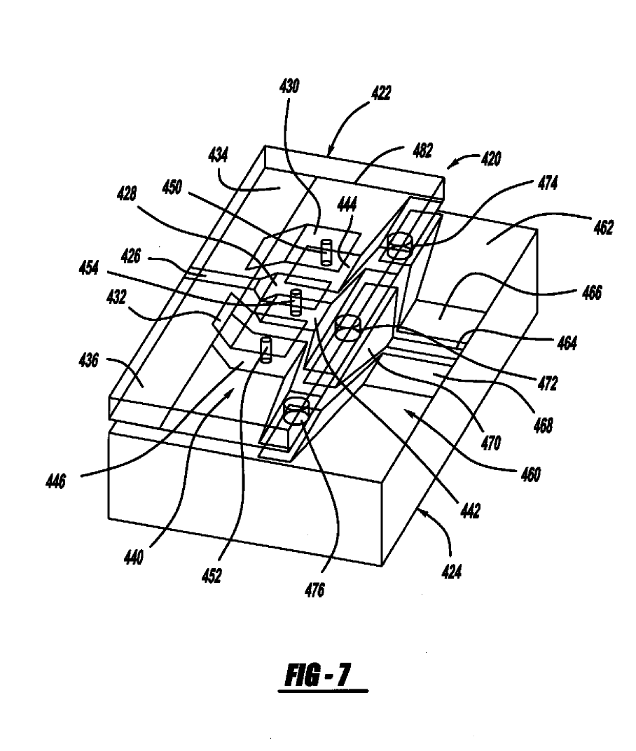

FIG. 6(a) is a top view and FIG. 6(b) is a bottom view of a semiconductor wafer 240 showing a microstrip-to-CPW transition 242 from a top surface 244 of the wafer 240 to a bottom surface 246 of the wafer 240. The wafer 240 can be any suitable semiconductor wafer for the purposes described herein, such as a group III-V semiconductor or silicon wafers. Further, the wafer 240 can have a thickness of 100 μm or less. An input microstrip line 248 and an output microstrip line 250 are formed on the top surface 244 of the wafer 240. The microstrip line 248 includes a flared and widened portion 252 to provide impedance matching and electrical coupling to an input signal via 254 extending through the wafer 240, and the output microstrip line 250 includes a flared and widened portion 256 that provides impedance matching and electrical coupling to an output signal via 258 extending through the wafer 240.

A first input ground plane 260 and a second input ground plane 262 are formed on the top surface 244 of the wafer 240 on opposite sides of the extended portion 252, as shown. A ground via 264 extending through the wafer 240 is electrically coupled to the ground plane 260 and a ground via 266 extending through the wafer 240 is electrically coupled to the ground plane 262. Likewise, a first output ground plane 268 and a second output ground plane 270 are formed on the top surface 244 of the wafer 240 on opposite sides of the extended portion 256 of the microstrip line 250, as shown. A ground via 272 extending through the wafer 240 is electrically coupled to the ground plane 268 and a ground via 274 extending through the wafer 240 is electrically coupled to the ground plane 270.

An input CPW 280 and an output 282 are formed on the bottom surface 246 of the wafer 240. The input CPW 280 and the output CPW 282 include a common signal line 284, where the signal line 284 includes a widened portion 286 that forms part of the input CPW 280 and a widened portion 288 that forms part of the output CPW 282. The widened portion 286 is electrically coupled to the signal via 254 and includes a flared portion for impedance matching purpose. Likewise, the widened portion 288 is electrically coupled to the signal via 258 and includes a flared portion for impedance matching purposes. The input CPW 280 includes a ground plane 290 having opposing waveguide portions 292 and 294 on opposite sides of the widened portion 286. The waveguide portion 292 is electrically coupled to the ground via 266 and the waveguide portion 294 is electrically coupled to the ground via 264. Likewise, the output CPW 282 includes a ground plane 296 having opposing waveguide portions 298 and 300 on opposite sides of the widened portion 288. The waveguide portion 298 is electrically coupled to the ground via 274 and the waveguide portion 300 is electrically coupled to the ground via 272.

FIG. 7 is a perspective view of a wafer-to-wafer transition 420 between a top wafer 422 and a bottom wafer 424. The top wafer 422 includes an input microstrip line 426 having a widened portion 428 formed on a top surface 434 of the wafer 422. A ground plane 436 is formed on a bottom surface of the top wafer 422 for the microstrip line 478. The top wafer 422 also includes ground planes 430 and 432 formed on the top surface 434 of the wafer 422. A short finite CPW 440 is also formed on the bottom surface of the wafer 422 and includes a signal line 442 and opposing ground planes 444 and 446 both coupled to the ground plane 436. An RF via 450 extending through the top wafer 422 is electrically coupled to the widened portion 428 of the ground plane 430 and the ground plane 444. An RF via 452 extending through the top wafer 422 is electrically coupled to the ground plane 432 and the ground plane 446. An RF via 454 extending through the top wafer 422 is electrically coupled to the microstrip line 426 and the signal line 442. Thus, a microstrip-to-CPW transition is provided through the top wafer 422 of the type described with reference to FIGS. 6(a) and 6(b).

A short finite output CPW 460 is formed on a top surface 462 of the bottom wafer 424, and includes a signal line 464 and opposing ground planes 466 and 468, where the signal line 464 includes a widened portion 470. A metallized bump 472 provides an electrical connection between the signal line 442 and the signal line 464, a metallized bump 474 provides an electrical connection between the ground plane 444 and the ground plane 466, and a metallized bump 476 provides an electrical connection between the ground plane 446 and the ground plane 468, where the bumps 472, 474 and 476 are provided between the wafers 422 and 424.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A semiconductor wafer comprising a microstrip-to-coplanar waveguide transition, said wafer including a first surface and a second surface, said wafer further including an input microstrip line formed on the first surface, an output microstrip line formed on the first surface, a first ground plane formed at one side of the input microstrip line on the first surface, a second ground plane formed at the other side of the input microstrip line on the first surface, a third ground plane formed at one side of the output microstrip line on the first surface and a fourth ground plane formed at the other side of the output microstrip line on the first surface, said wafer further including a coplanar waveguide formed on the second surface of the wafer, said coplanar waveguide including a signal line surrounded by and electrically separated from a fifth ground plane, said wafer further including a first via extending through the wafer and electrically coupling the first ground plane and the fifth ground plane, a second via extending through the wafer and electrically coupling the second ground plane and the fifth ground plane, a third via extending through the wafer and electrically coupling the third ground plane and the fifth ground plane, a fourth via extending through the wafer and electrically coupling the fourth ground plane and the fifth ground plane, a fifth via extending through the wafer and electrically coupling the input microstrip line and one end of the signal line and a sixth via extending through the wafer and electrically coupling the output microstrip line and an opposite end of the signal line.

2. The wafer according to claim 1 wherein the input microstrip line includes a flared and widened portion electrically coupled to the fifth via, the output microstrip line includes a flared and widened portion electrically coupled to the sixth via, the one end of the signal line includes a flared and widened portion electrically coupled to the fifth via and the other end of the signal line includes a flared and widened portion electrically coupled to the sixth via.

3. The wafer according to claim 1 wherein the wafer is a silicon wafer.

4. The wafer according to claim 1 wherein the wafer is a group III-V semiconductor wafer.

5. The wafer according to claim 1 wherein the wafer is 100 μm in thickness or less.

6. A semiconductor device comprising:
a first wafer including a first surface and a second surface, said first wafer further including a microstrip line formed on the first surface of the first wafer, a first ground plane formed on the first surface of the first wafer adjacent to the microstrip line and a second ground plane formed on the first surface of the first wafer adjacent to the microstrip line, said first wafer further including a first short finite coplanar waveguide formed on the second surface of the first wafer, said first coplanar waveguide including a first signal line and a third ground plane surrounding the signal line, said first wafer further including a first via extending through the first wafer and electrically coupling the microstrip line to the first signal line, a second via extending through the first wafer and electrically coupling the first ground plane to the third ground plane and a third via extending through the first wafer and electrically coupling the second ground plane and the third ground plane;
a second wafer including a first surface and a second surface, said second wafer further including a second short finite coplanar waveguide formed on the first surface of the second wafer, said second coplanar waveguide including a second signal line, a fourth ground plane adjacent to one side of the second signal line and a fifth ground plane adjacent to another side of the second signal line; and
a plurality of electrical bumps making electrical contract between the first wafer and the second wafer, a first one of the electrical bumps electrically coupling the fourth ground plane to the third ground plane, a second one of the electrical bumps electrically coupling the first signal line and the second signal line and a third one of the electrical bumps electrically coupling the fifth ground plane and the third ground plane.

7. The device according to claim 6 wherein the microstrip line includes a flared and widened portion electrically coupled to the first via, the first signal line includes a flared and widened portion electrically coupled to the second bump, and the second signal line includes a flared and widened portion electrically coupled to the second bump.

8. The device according to claim 6 wherein the first and second wafers are silicon wafers.

9. The device according to claim 6 wherein the first and second wafers are group III-V semiconductor wafers.

10. The device according to claim 6 wherein the first and second wafers are 100 μm in thickness or less.

11. A semiconductor device comprising:
a first wafer including a first surface and a second surface, said first wafer further including a microstrip line formed on the first surface of the first wafer and a first coplanar waveguide formed on the second surface of the first wafer, said microstrip line and said first coplanar waveguide being electrically coupled by vias extending through the first wafer;
a second wafer including a first surface and a second surface, said second wafer including a second coplanar waveguide formed on the first surface of the second wafer; and
a plurality of electrical bumps electrically coupling the first and second coplanar waveguides.

12. The device according to claim 11 wherein the first wafer further includes a first ground plane formed on the first surface of the first wafer adjacent to the microstrip line and a second ground plane formed on the first surface of the first wafer adjacent to the microstrip line, said first coplanar waveguide including a signal line and a third ground plane surrounding the signal line, wherein the vias include a first via extending through the first wafer and electrically coupling the microstrip line to the first signal line, a second via extending through the first wafer and electrically coupling the first ground plane to the third ground plane and a third via extending through the first wafer and electrically coupling the second ground plane to the third ground plane.

13. The device according to claim 12 wherein the microstrip line includes a flared and widened portion electrically coupled to the first via and the signal line includes a flared and widened portion.

14. The device according to claim 11 wherein the second coplanar waveguide includes a signal line formed on the first surface of the second wafer, a first ground plane formed on the first surface of the second wafer adjacent to one side of a second signal line and a second ground plane formed on the first surface of the second wafer adjacent to another side of the signal line.

15. The device according to claim 14 wherein the signal line includes a flared and widened portion electrically coupled to an electrical bump.

16. The device according to claim 11 wherein the first and second wafers are silicon wafers.

17. The device according to claim 11 wherein the first and second wafers are group III-V semiconductor wafers.

18. The device according to claim 11 wherein the first and second wafers are 100 μm in thickness or less.

19. The device according to claim 11 wherein the first and second coplanar waveguides are short finite waveguides.
